(19) United States
(12) Patent Application Publication
(10) Pub. No.: US 2003/0051819 A1
(43) Pub. Date: Mar. 20, 2003

(54) Apparatus for manufacturing packaging or cushioning products comprising popped grains and the resultant product

(76) Inventor: Luc de Moustier, Paris (FR)

Correspondence Address: SCHNADER HARRISON SEGAL & LEWIS, LLP, 1600 MARKET STREET, SUITE 3600, PHILADELPHIA, PA, 19103

(21) Appl. No.: 10/141,296

(22) Filed: May 8, 2002

Related U.S. Application Data
(63) Continuation of application No. PCT/FR00/03150, filed on Nov. 10, 2000.

(30) Foreign Application Priority Data
Nov. 10, 1999 (FR) 99/14163

(51) Int. Cl. B32B 31/00

(52) U.S. Cl. 156/561; 156/562; 156/569; 156/583.1; 206/584; 206/814

(57) ABSTRACT

An apparatus for manufacturing a packaging or cushioning product made from grains comprising an essentially flat support, means for driving the support in translational movement, means for depositing on the support a first fiber sheet, means for distributing popped or unpopped grains on the fiber sheet; means for spreading the grains on the fiber sheet to thereby form a layer of grains, means for depositing a second fiber sheet on the layer of grains, and means for attaching the fiber sheets to each other to at least partially separate said grains to form the packaging or cushioning products.

### RELATED APPLICATION

This is a continuation of International Application No. PCT/FR00/03150, with an international filing date of Nov. 10, 2000, which is based on French Patent Application No. 99/14163, filed Nov. 10, 1999.

### FIELD OF THE INVENTION

This invention relates to the field of packaging and, more specifically, a machine for manufacturing packaging or cushioning products comprising popped grains.

### BACKGROUND

A loose cushioning product in the form of a multiplicity of independent plastic elements is well known in the art. Also known are other packaging products made of synthetic material and available in the form of sheets, such as plastic sheets incorporating air bubbles or forming shells to fit the contours of the product to be protected, as well as thick packaging products of the expanded polystyrene type.

All of these packaging or cushioning products are bulky and, therefore, transporting them to the factories where the articles are manufactured is expensive. In addition, these products are made of plastic. Therefore, after their use, they constitute polluting waste materials whose treatment poses notable environmental problems.

WO 87/06209 describes a material with popped grains forming a filling volume. In the product according to WO 87/06209, the granular materials are intended to fill the volume of the tubular envelope to form a granular mass having a global mechanical performance that is different than the individual performance of each of the grains.

WO 92/04253 describes a cushioning or packaging material made of popped grains. This material can be constituted by popped grains in the free state, placed in biodegradable envelopes or molded with a biodegradable binder to form a relatively rigid structure. This material makes it possible to reduce the amount of polluting waste products, but it nevertheless presents certain disadvantages.

First, the loose material is relatively compact and, therefore, heavy. Furthermore, it does not effectively protect an object that it surrounds since this object has a tendency to pass through the loose material, especially under the effect of an impact. Moreover, vibrations occurring during transport also lead to a displacement of the object in the loose material. It is, therefore, necessary to provide exterior packaging of a larger size containing the loose material, which results in higher costs.

The envelopes filled with loose material must be relatively thick to be effective. These envelopes, therefore, necessarily occupy a large volume and are relatively heavy.

Finally, a compact material based on popped grains requires a specific mold for each product to be packaged, which increases the manufacturing costs. Moreover, such a material has practically no empty spaces and is, therefore, relatively heavy.

It would, therefore, be advantageous to resolve these disadvantages by providing a machine for manufacturing packaging or cushioning products which are biodegradable and relatively light, but still effectively protect an article against impacts, with it being possible to conform these products to fit the contours of the article to be protected.

It would be advantageous to design a machine to be in simple operation and can thus be used at the packaging site itself to eliminate the costs associated with transporting the packaging products. SUMMARY OF THE INVENTION

This invention relates to an apparatus for manufacturing a packaging product made from grains including a substantially flat support formed from elongated support members, a motor to move the support members, a sheet dispenser positioned to deposit a first fiber sheet on at least some of the support members, a grain dispenser positioned to distribute grains onto the first fiber sheet, a spreader located downstream of the grain dispenser to form a layer of grains, a second sheet dispenser positioned to deposit a second fiber sheet on the layer of grains, and a fiber sheet bonder that attaches the fiber sheets to each other at selected locations to at least partially separate the grains.

The invention also relates to a packaging or cushioning product including at least two essentially cylindrical envelopes formed of fibers and at least partially filled by popped grains, the envelopes being essentially parallel to each other and attached to each other along their largest dimension.

### BRIEF DESCRIPTION OF THE DRAWINGS

Better comprehension of the invention and its other goals, advantages and characteristics will be provided by the description below with reference to the attached drawings in which:

FIG. 1 is a partial perspective view of an example of a machine according to the invention;

FIG. 2 is a side view taken along direction II of FIG. 1;

FIG. 3 is a sectional view taken along line III-III of FIG. 2;

FIG. 4 is a partial perspective view of a first packaging or cushioning product obtained with a machine according to the invention;

FIG. 5 is a top view of a second packaging or cushioning product obtained with a machine according to the invention;

FIG. 6 is a top view of a third packaging or cushioning product obtained with a machine according to the invention;

FIG. 7 is perspective view of the product in FIG. 6 in the process of being filled;

FIG. 8 is a sectional view of a fourth packaging or cushioning product according to the invention;

FIGS. 9 and 10 represent one variant of implementation of a machine according to the invention;

FIGS. 11 and 12 represent two variants of implementation of a material according to the invention;

FIG. 13 represents a top view of a material for the creation of a three-dimensional anti-impact packaging; and

FIGS. 14 to 18 represent packaging at successive stages of assembly.

### DETAILED DESCRIPTION

It will be appreciated that the following description is intended to refer to specific embodiments of the invention selected for illustration in the drawings and is not intended to define or limit the invention, other than in the appended claims.

The invention concerns a machine for the manufacture of packaging or cushioning products comprising popped grains, with this machine comprising:

at least one essentially flat support,

means for driving the support in translational movement,

means for depositing on the support a fiber sheet which is held in place,

means for distributing popped or unpopped grains on the fiber sheet,

means for spreading the grains on the fiber sheet to thereby form a layer of grains,

means for depositing another fiber sheet on top of the layer of grains and

means for attaching the two fiber sheets to each other at least partially separating the grains.

The support preferably comprises at least one concave reception zone for a fiber sheet.

In one advantageous mode of implementation of the machine, it comprises at least two essentially linear guides substantially parallel to each other, with a fiber sheet deposited between two adjacent guides forming a trough. The spacing between the guides is preferably variable.

In an advantageous manner, the means for distributing the grains are designed to distribute the grains essentially linearly between two adjacent guides and consist, for example, of a rotary brush.

The means for attaching the two fiber sheets to each other are designed to create bonds between the sheets which extend essentially along the guides.

In a preferred mode of implementation of the machine, the means for attaching the two fiber sheets to each other comprise rollers mounted on the guides and which cooperate with other rollers located above the guides and capable of being applied with a determined pressure on the other fiber sheet, with the cooperation between two rollers generating an essentially continuous bond between the two fiber sheets.

The machine according to the invention advantageously comprises means for holding in place a fiber sheet on the guides consisting of means creating a depression under the guides, the fiber sheet being furthermore subjected to a determined tension at the level of the two outside guides.

The means for distributing the grains are advantageously associated with control means for regulating the spatial distribution of the grains.

In a preferred mode of implementation of the machine according to the invention, the means for distributing and spreading the grains on the fiber sheet consist of a vibrating tray with openings along lines essentially parallel to each other and spaced apart by a distance corresponding essentially to the spacing between the guides.

In one particular mode of implementation of the machine according to the invention, the machine has means for selectively removing grains after they have been deposited on the fiber sheet, notably by suction.

The machine according to the invention also comprises means for causing the popping of the grains before or after they have been deposited on the fiber sheet.

Finally, when the means for popping the grains are employed before the grains are deposited on the fiber sheet, the machine also comprises means for treating the grains so as to make them essentially round, which means are employed prior to the distribution of the grains on the fiber sheet.

The invention also concerns a packaging or cushioning product obtained by the machine according to the invention, this product being constituted by an essentially cylindrical envelope formed of fibers and at least partially filled by popped grains.

The invention also concerns a product comprising at least two essentially cylindrical envelopes formed of fibers and at least partially filled by popped grains, the envelopes being essentially parallel to each other and attached to each other along their largest dimension.

The popped grains are deposited individually on the support and have a section close to the section of the tubular envelope. The product according to the invention, thus, best exploits the mechanical characteristics of the popped grains.

The performance characteristics that result from the viscous interaction of the grains are comparable to that of an incompressible, but deformable fluid, whereas the product according to the invention has performance characteristics comparable to that of a compressible solid. This difference is essential for attaining the desired results. Furthermore, local tearing of the product according to the prior art results in a major degradation in the qualities of the product, because of the loss of grains and, thus, modification in the overall performance of the filling material. Because of the fluid-type behavior, a tear in the envelope causes a leak, resulting in a flowing out of a large portion of the granular filling. This phenomenon affects the entirety of the cushioning product and not just the local area where the tear took place.

With the product according to the invention, in contrast, a local degradation of the envelope will not result in a local degradation of the cushioning product's performance. The other popped grains will continue to independently provide their cushioning function without being disturbed by the local disturbance.

The diameter of the envelope(s) preferably corresponds essentially to the average diameter of the popped grains employed.

The fibers employed in the composition of the product have advantageously undergone fire-resistance, insect-resistance, moisture-resistance or antistatic treatment.

In one particular mode of implementation, at least one envelope of the packaging or cushioning product has a zone free of grains, with these zones being distributed to form concave parts.

In another mode of implementation of the packaging or cushioning product according to the invention, this product comprises at least two series of cylindrical envelopes filled at least in part by grains and attached to each other, with these series being themselves attached to each other by a grain-free fibrous zone and enabling the folding of the product so as to form a shell.

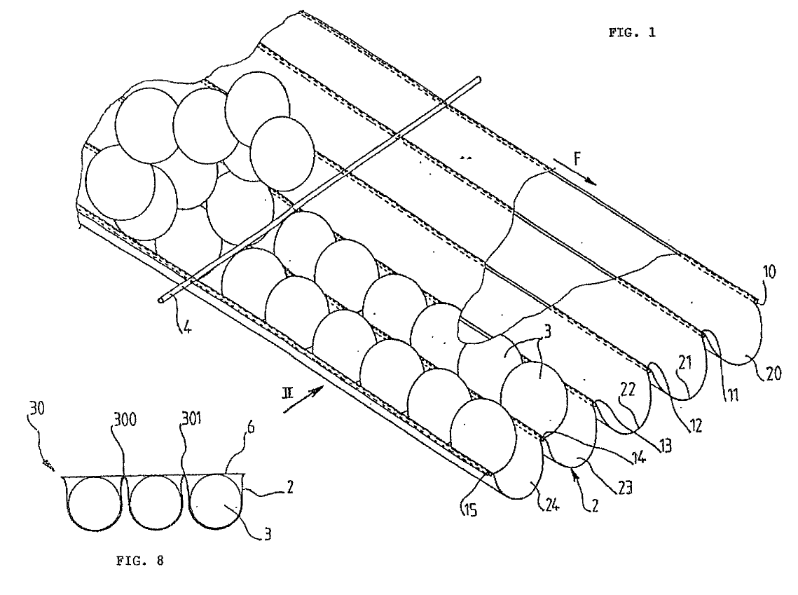

Turning now to the drawings, the elements that are common to the different figures will be designated by the same reference numbers. FIG. 1 illustrates part of a machine according to the invention and shows, in particular, a multiplicity of guides referenced 10 to 15. These guides are essentially linear and essentially parallel to each other. Furthermore, the spacing between two guides is adjustable. As will be seen below, this feature makes it possible to vary the density of the grains in the final packaging product.

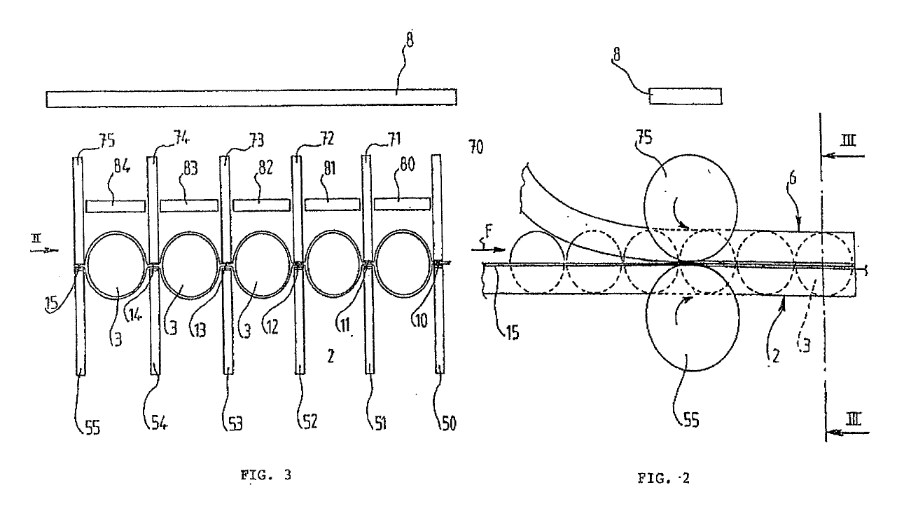

Guides 11 to 15 can especially be in the form of belts driven in translational movement by appropriate means as will be explained with reference to FIGS. 2 and 3. The machine according to the invention also comprises means (not shown) which make it possible to deposit a fiber sheet 2 on the guides 11 to 15. This fiber sheet 2 is held in place on the guides, for example, by applying a suitable tension on the fiber sheet 2 at the level of the outside guides 10 and 15.

Furthermore, in the example illustrated in FIG. 1, the machine according to the invention also comprises means for creating a depression at the bottom part of guides 11 to 15. These means (not shown in FIG. 1) make it possible to firmly apply the sheet 2 against the guides. Moreover, the sheet 2 is slightly deformed under the multiplicity of guides 11 to 15. As illustrated in FIG. 1, the sheet 2 forms between two adjacent guides a trough 20, 21, 22, 23, 24, whose concavity faces the guides.

The machine according to the invention also comprises means for distributing the grains 3 on the fiber sheet 2. These means 5 (not illustrated in FIG. 1) can especially consist of a hopper, for example. Moreover, in the example illustrated in FIG. 1, the grains that are deposited on the sheet 2 are popped grains. However, it is also possible to provide for depositing unpopped grains on this sheet, in which case the grains will be popped subsequently.

Due to the troughs 20 to 24 formed by the sheet 2, the grains 3 are easily positioned between two adjacent guides. The grains 3 are, thus, distributed essentially linearly between two adjacent guides, but other distributions of the grains 3 could also be envisaged.

FIG. 1 illustrates schematically the means for distributing the grains on the sheet 2 and are constituted by a rotary brush 4. This brush functions in the following manner.

The guides 11 to 15 with the sheet 2 are driven by a translational movement which is indicated by the arrow F. The rotary brush 4 is fixed translationally and is driven by a rotational movement in the clockwise direction.

Thus, when the grain-distribution means are constituted by a hopper, the grains are deposited in bulk on the fiber sheet. The grains in bulk are illustrated in FIG. 1 upstream of the brush 4, in relation to the running direction of the guides and the sheet, indicated by the arrow F. The rotary brush 4 is fixed above the guides 1 to 15 at a height such that it pushes downstream of the brush the grains which are not placed in the troughs. In the example of implementation illustrated in the figures, this height is comprised between the average radius and the average diameter of the grains 3. Thus, by means of this rotary brush 4, the grains 3 are correctly deposited between two adjacent guides.

In another mode of implementation of the machine (not illustrated in FIG. 1), the means for distributing and spreading the grains on the fiber sheet are grouped together. They can then notably take the form of a vibrating tray that receives the grains 3.

This tray is designed in a manner to comprise elongated openings essentially parallel to each other and which are spaced apart from each other essentially by the distance corresponding to the spacing between the guides. The transverse dimension of these openings is selected such that a single grain can pass through the opening in this transverse direction when the tray is made to vibrate.

In the example illustrated in FIG. 1, the grains 3 are distributed uniformly on the fiber sheet 2. These grains are deposited in the pleats of the cloth between two sheets which are spaced apart by a distance corresponding approximately to the section of the grains. These grains form a single thickness without overlapping each other to guarantee a constant mechanical behavior at all sites of the material formed.

The grains do not overlap each other and can be contiguous, or preferably slightly spaced apart to avoid any contact between two adjacent grains. It is also possible to envisage distribution means performing a nonuniform spatial distribution of the grains, with these means then being, for example, controlled by suitable means for regulating this spatial distribution. These means could, for example, consist of lugs or studs at the sites which must be free of grains to prevent depositing of grains at these sites; the means are subsequently withdrawn.

It is also possible to envisage conserving a uniform spatial distribution of the grains and providing in the machine means for extracting selectively the grains after they have been deposited, with this extraction being performed especially by suction. A nonuniform distribution of the grains can, notably, make it possible to create in the packaging or cushioning product obtained with the machine according to the invention a space for an article to be cushioned or to fold the packaging product so as to form spaced-apart cushions. This will be described below with reference to FIGS. 5, 6 and 7.

We will now refer to FIGS. 2 and 3 to describe other constitutive means of the machine according to the invention. Shown in both of these figures are the guides referenced as numbers 10 to 15 and presented in the form of belts which are driven in translational movement by means which are not illustrated. These means, thus, cause a translational movement of the sheet 2 according to the arrow F.

The machine also comprises other means for depositing on the grains 3 another fiber sheet referenced with number 6. These means are not illustrated in the figures. The sheet 6 is deposited at the same rate as the advancement of the sheet 2 and the grains 3 distributed on this sheet 2.

The machine according to the invention also comprises means for attaching the two fiber sheets 2 and 6 to each other. In the example of implementation illustrated in the figures, these means are constituted by the rollers 50 to 55 and 70 to 75. Each of these rollers 70 to 75 is positioned above a guide 10 to 15, respectively, and essentially facing another roller 50 to 55, respectively, located above a guide 10 to 15, respectively.

These rollers 70 to 75 are heated by any suitable means and especially by a heater bar 8. Furthermore, these rollers 50 to 55, on the one hand, and 70 to 75, on the other, are in a relative position such that pressure is exerted on the two sheets 2 and 6 when they pass between two rollers.

When the fiber sheets are made of a partially thermoplastic material or of a material coated with a suitable hot-melt adhesive, the passage of the sheets between the two rollers causes welding together of the two sheets at the level of the guides 10 to 15.

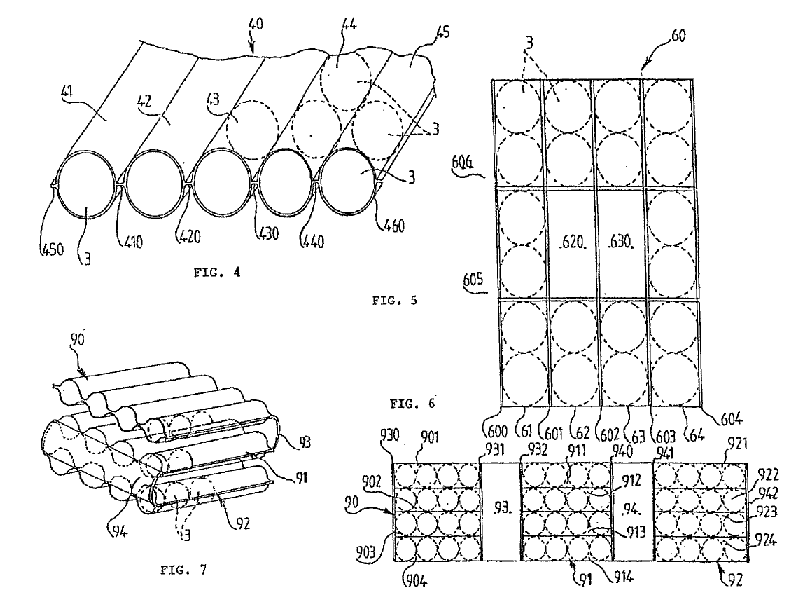

The machine according to the invention, thus, can produce a packaging or cushioning product constituted by a series of fiber envelopes of cylindrical form filled with grains 3 and attached to each other in a manner to be essentially parallel to each other. Such a packaging product 10 is illustrated in FIG. 4.

In the example of implementation of the machine illustrated in FIGS. 2 and 3, there are preferably provided heat insulators 80 to 84 above each row of grains, between two guides, to protect the grains 3 from the heat generated by the heater bar 8. In this example of implementation, the attachment between the two sheets 2 and 6 is obtained by welding.

The invention is not limited to this mode of implementation and it is also possible to provide for the attachment of the sheets to each other by means of an adhesive applied by rollers or other means, by stitching or by application of ultrasound.

Moreover, the support for the fiber sheet can have other forms. It can, for example, be constituted of hollowed-out zones, especially of alveolar shape or troughs, possibly combined with flat zones. The support can also be flat, with the grains being positioned on the fiber sheet on the support, for example, with points or ribbons of adhesive previously deposited on the fiber sheet. The machine can also comprise, in association with a flat support, means for forming a fiber sheet by creating concave zones for receiving the grains.

It is also possible to provide means for attaching the sheets directly onto the grains, with the separation between the grains consisting of an empty space. It is then advantageous to distribute in a suitable manner an adhesive material on the sheets or directly on the grains.

Reference will now be made to FIG. 4 which illustrates a packaging or cushioning product 40 obtained with the machine described above. This packaging product is in sheet form and it comprises five cylindrical fiber envelopes 41 to 45 filled with grains 3. These fiber envelopes are attached to each other by the bonds 410 to 440 in a manner such that the envelopes extend essentially parallel to each other. The two end envelopes 41 and 45 are closed on their free side by another bond 450, 460. The bonds 410 to 440 correspond to the zones in which the sheets 2 and 6 were attached to each other by the previously described machine. In this packaging product, the popped grains are, thus, held in rows separated from each other. The resultant packaging product is light, but still exhibits a notable resistance to impacts.

As previously indicated, the surface mass of the grains can be controlled by means of the variable spacing between the guides 10 to 15. As a function of this spacing between the guides, the bonding zones 410 to 440 can extend more or less in the transverse direction of the envelopes 41 to 45.

Another packaging product according to the invention (not illustrated) consists of a cylindrical fiber envelope at least partially filled by grains. A product of this type can be rolled around an article to be protected.

As previously explained, the machine according to the invention can also be controlled in a manner such that the grains 3 are not distributed in a uniform manner on the sheet 2.

FIG. 5 illustrates another example of a packaging product 60 obtained with the machine according to the invention. FIG. 5 is a top view of this packaging material which is also in sheet form like that illustrated in FIG. 4. This material comprises four fiber envelopes 61, 62, 63, 64 which are filled with grains 3. They are attached to each other by the bonds 601, 602, 603, with the end envelopes 61 and 64 being closed at their free side by another bond 600, 604. FIG. 5 shows that this material comprises a grain-free zone 620, 630 which is here located essentially at the center of the packaging product. Thus, in this zone, the packaging product comprises solely two superposed fiber sheets.

In order to retain the grains, two supplementary bonds 605 and 606 are provided perpendicular to the bonds 600 to 604. Such a packaging material can notably be used for cushioning objects whose size corresponds to the dimensions of the grain-free zone 620, 630. Such an article can also be cushioned by superposing packaging products as described in FIG. 5 in a manner such that the grain-free zones coincide.

In this case, the fibers present in the grain-free zones can also be removed. In FIG. 6, this packaging product is constituted of three series of cylindrical envelopes 90, 91 and 92. Each of these series is constituted of four cylindrical envelopes 901 to 904; 911 to 914 and 921 to 924.

In each of these series, the cylindrical envelopes are filled with popped grains and attached to each other in a manner such as to be essentially parallel to each other. Each of these series is separated by a zone 93 and 94 which is completely free of grains. These zones, thus, extend transversely to the unwinding direction of the fiber sheet 2 and the grains 3 in the machine and their largest dimension is substantially perpendicular to the cylindrical envelopes. This distribution is obtained by suppressing the distribution of grains along a determined length of the sheet 2 illustrated in FIG. 1.

The sheets employed in the composition of the packaging product are preferably attached to each other by bonds essentially perpendicular to the direction in which the envelopes extend. These bonds are designated by reference numbers 930, 931, 932, 940, 941, 942.

As illustrated in FIG. 7, the packaging product 90 illustrated in FIG. 6 can be folded at the level of the grain-free zones 93 and 94, which allows presentation of the packaging product in the form of a pillow. This folding is performed transversely in relation to the envelopes.

As a variant, another distribution of the grains can be obtained by suppressing the distribution of grains in zones extending along the direction of unwinding of the sheet 2 and the grains 3 in the machine. These grain-free zones are then located in the resultant packaging or cushioning product between series of cylindrical envelopes at least partially filled with grains such that their largest dimension is parallel to these envelopes 35. The resultant product can also be folded to form a pillow. This folding is performed parallel to the envelopes. (It is not illustrated in the figures.)

The fiber sheets employed in the composition of the packaging product obtained with the machine according to the invention can be made of synthetic or natural fibers. Nonwoven sheets of polypropylene, linen or cotton are examples. The fiber sheets employed have preferably been subjected in advance to fire-resistance, moisture-resistance or insect-resistance treatment. It is also possible to use fiber sheets 15 having a certain elasticity to improve the impact-absorbing capacity of the packaging product according to the invention.

Furthermore, the description above refers to fiber envelopes whose thickness corresponds essentially to the average diameter of the popped grains. It is also possible to envisage a different distribution of the grains, with the envelopes then containing more than one grain in their section.

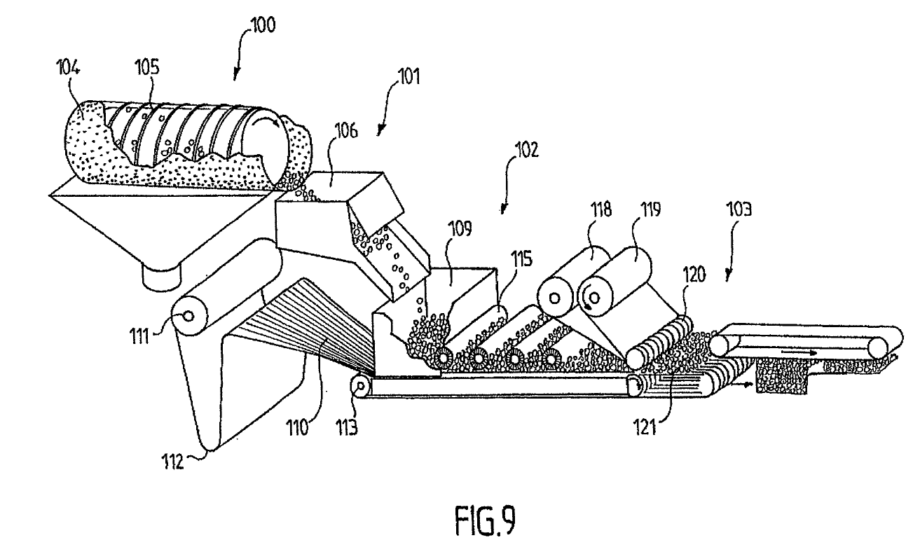

Moreover, the figures illustrate envelopes formed of two fiber sheets, with each of the sheets forming essentially half of the envelope. The invention is not limited to this mode of implementation and the distribution of the fiber sheets around the grains could be different. Reference can be made especially to FIG. 8 which shows a variant of the packaging or cushioning product illustrated in FIG. 1. In this product 30, the bonds 300 and 301 between the bottom sheet 2 and the top sheet 6 are located at the level of the top part of the grains 3 rather than at the level of the middle of the grains as illustrated in the other figures.

The grains used are grains that can be popped such as corn, rice, wheat or sorghum grains. The bonds between the two fiber sheets that have been described extend in two essentially perpendicular direction. It is also possible to envisage bonds extending in any direction in the plane of the fiber sheets.

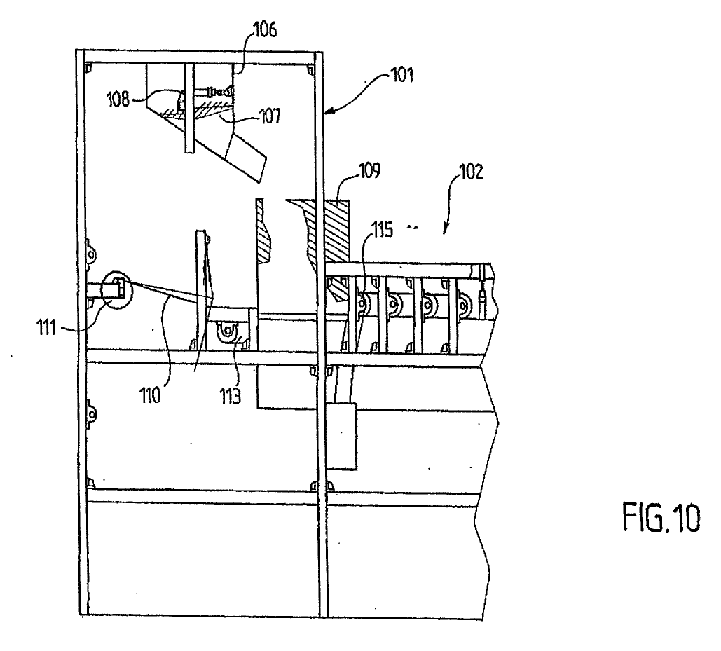

FIGS. 9 and 10 represent variants of implementation of the equipment according to the invention. The machine comprises a first station 100 for cleaning the popped grains, a second distribution station 101 providing for metering and distribution of the grains, a deposition station 102 providing for distribution of the grains on the envelope sheets and a forming station 103.

The distribution station 101 comprises a perforated envelope 104 within which the popped grains are driven by a driving means such as a worm gear 105. The perforated envelope 101 is constituted by a perforated plate having holes approximately 10 mm in diameter. It is positioned substantially horizontally or vertically.

The grains are driven to the interior of this envelope and worn down upon contact with the perforated surface. This eliminates the irregularities from the grains and functions as an outlet from this station for the nearly spherical grains of calibrated volume. Making the grains nearly spherical eliminates the possibility that grains of irregular form could change the mechanical behavior of the formed material.

The popped grains flow into a receptacle 106 with a trapdoor 107. A level detector 108 allows regulation of the flow rate from this first box and control of the feeding rate. The opening and closing of the trapdoor 107 is controlled by a level detector installed on the second receptacle 109. The grains coming from the first receptacle fall into this second receptacle 109, which causes a natural effect of dispersion and homogenization of the mass of grains.

This receptacle 109 is of a smaller volume that the first receptacle 106 thereby forming a buffer volume. This prevents the agglomeration and compacting of the grains before they can be deposited on the support cloth.

The cloth 110 is fed by a roll 111 with a tension regulator 112. It is deformed by fingers 113 forming longitudinal pleats in which the grains will be placed.

Transverse brushes 115 provide for the distribution of the grains into the troughs formed by the pleats of the cloth.

The tissue thereby filled with popped grains is covered by a first heat-sealing film 118 and a second cloth film 119. Heating rollers 120 create the bond between the bottom film 110 and the top films 119, 118.

Transverse welding means 121 can produce a welding line separating, for example, a zone comprising popped grains from a zone free of popped grains. Such a machine can produce cloths such as those represented in FIGS. 11 or 12.

In the first example, two sheets are formed and then assembled “head-to-tail”. The first sheet has an exterior cloth 130, an intercalated biodegradable film 131 and an interior film 132. The popped corn grains 134 are placed in longitudinal pleats. Two consecutive pleats 135, 135 are separated by a corn-free row 137. The complementary sheet is fitted on the first sheet. The lateral sides 140, 141 are connected to form an impact-absorbing pad.

In the example represented in FIG. 12, certain zones (150) of the sheets are devoid of the bottom cloth to allow local welding by means of the intercalated film 151.

It is, thus, possible to create complicated structures by the well thought-out selection of corn-free zones facilitating folding of the sheet, zones free of corn and of interior cloth for forming longitudinal or transverse bonding zones, and zones in which the grains form single rows with popped grains in the section corresponding essentially to the section of the longitudinal trough in which they are deposited without covering and without excessive thickness.

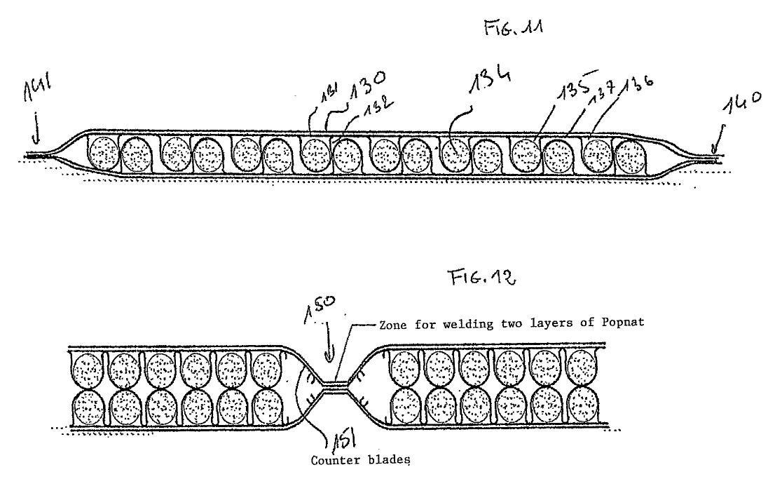

FIG. 13 represents a top view of a material constituted by sheets enclosing popped grains. This material presents zones 250 with grains in a tubular envelope formed by the welding together of a top sheet and a bottom sheet by weld lines parallel to the rows of grains. It also has grain-free zones 251 intended to be cut and weld bands 252, 253 intended to facilitate shaping by folding.

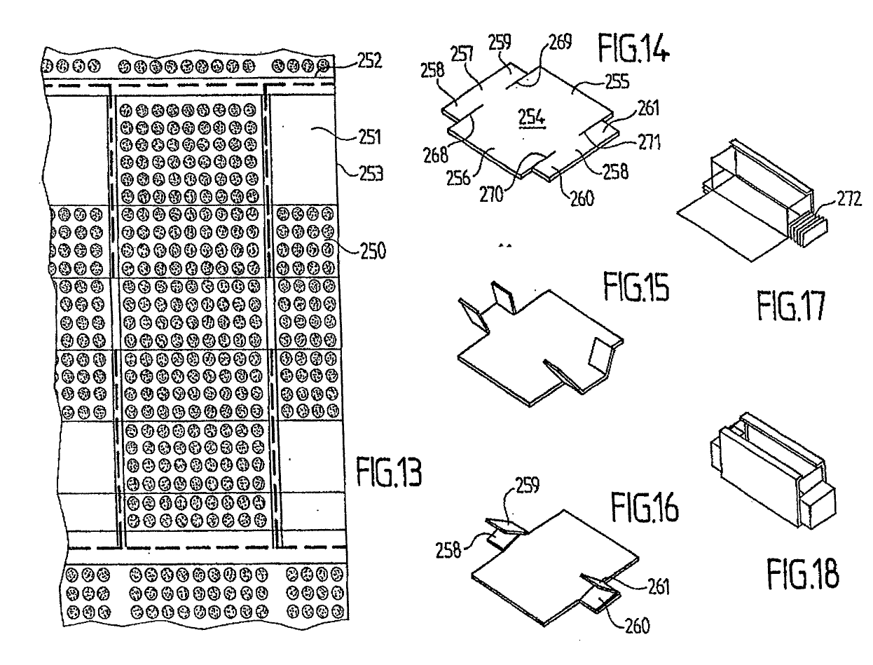

Certain zones are cut out to form an element represented in FIG. 14. This element has a central part 254 extended by lateral flanks 255, 256 and flaps 257, 258. These flaps have present tabs 258 to 261 separated from the lateral flanks 255, 256 by cut-outs 268 to 271. The material is then folded as represented in FIGS. 15 to 18. Additional pillows 272 can be introduced into the packaging.

1. Apparatus for manufacturing a packaging or cushioning product made from grains comprising:
an essentially flat support;
means for driving the support in translational movement;
means for depositing on the support a first fiber sheet;
means for distributing popped or unpopped grains on the fiber sheet;
means for spreading the grains on the fiber sheet to thereby form a layer of grains;
means for depositing a second fiber sheet on the layer of grains; and
means for attaching the fiber sheets to each other to at least partially separate said grains to form the packaging or cushioning products.

2. The apparatus according to claim 1, wherein the support comprises at least one concave reception zone for the first fiber sheet.

3. The apparatus according to claim 2, wherein the support comprises at least two essentially linear guides substantially parallel to each other and arranged such that a fiber sheet deposited on adjacent guides forms a trough.

4. The apparatus according to claim 3, wherein spacing between the guides is variable.

5. The apparatus according to claim 3, wherein the means for distributing the grains distributes the grains essentially linearly between two adjacent guides.

6. The apparatus according to claim 5, wherein the means for distributing the grains is a rotary brush.

7. The apparatus according to claim 3, wherein the means for attaching the fiber sheets to each other create bonds between the sheets which extend essentially along said guides.

8. The apparatus according to claim 7, wherein the means for attaching the two fiber sheets to each other comprise rollers mounted on the guides and which cooperate with other rollers located above the guides and are capable of being applied at a selected pressure on the another fiber sheet, with cooperation between two rollers generating an essentially continuous bond between the fiber sheets.

9. The apparatus according to claim 3, further comprising means for holding in place the first fiber sheet on the guides which includes means creating a depression under the guides such that the first fiber sheet is subjected to a selected tension at a level of outermost guides.

10. The apparatus according to claim 1, wherein the means for distributing the grains are connected to control means for regulating spatial distribution of the grains.

11. The apparatus according to claim 3, wherein the means for spreading the grains on the first fiber sheet include a vibrating tray with openings along lines essentially parallel to each other and spaced apart by a distance corresponding essentially to the spacing between the guides.

12. The apparatus according to claim 1, further comprising suction means for selectively removing grains after they have been deposited on the first fiber sheet.

13. The apparatus according to claim 1, further comprising means for popping the grains before or after depositing on the first fiber sheet.

14. The apparatus according to claim 13, further comprising means for treating the grains after popping, but before distribution on the first fiber sheet to make them essentially round.

15. A packaging or cushioning product comprising at least one essentially cylindrical envelope at least partially filled by a granular material popped grains, the popped grains being maintained in rows.

16. A packaging or cushioning product comprising at least two essentially cylindrical envelopes formed of fibers and at least partially filled by popped grains, the envelopes being essentially parallel to each other and attached to each other along their largest dimension.

17. The packaging or cushioning product according to claim 15, wherein the diameter of the envelope(s) corresponds essentially to the average diameter of the popped grains.

18. The packaging or cushioning product according to claim 15, wherein at least one envelope of the packaging or cushioning product having zones free of grains, the zones being distributed to form concave parts.

19. The packaging or cushioning product according to claims 15, comprising at least two series of cylindrical envelopes filled at least in part by grains and attached to each other, the series being attached to each other by a grain-free fibrous zone and enabling folding of the product to form a shell.

20. Apparatus for manufacturing a packaging product made from grains comprising:
a substantially flat support formed from elongated support members;
a motor to move the support members;
a sheet dispenser positioned to deposit a first fiber sheet on at least some of the support members;
a grain dispenser positioned to distribute grains onto the first fiber sheet;
a spreader located downstream of the grain dispenser to form a layer of grains;
a second sheet dispenser positioned to deposit a second fiber sheet on the layer of grains; and
a fiber sheet bonder that attaches the fiber sheets to each other at selected locations to at least partially separate the grains.
